(19) United States
(12) Patent Application Publication
(10) Pub. No.: US 2026/0253517 A1
(43) Pub. Date: Aug. 27, 2026

(54) ADJUSTABLE ELECTRONIC SHELF LABEL HOLDER

(71) Applicant: Fasteners for Retail, Inc., Twinsburg, OH (US)

(72) Inventors: Justin Joshua Campbell, Peatonica, IL (US); Robb Louis Northrup, Aurora, OH (US)

(73) Assignee: Fasteners for Retail, Inc., Twinburg, OH (US)

(21) Appl. No.: 19/546,543

(22) Filed: Feb. 23, 2026

Related U.S. Application Data
(60) Provisional application No. 63/762,122, filed on Feb. 24, 2025.

(51) Int. Cl. G09F 3/20

(52) U.S. Cl. CPC G09F 3/204; G09F 3/208

(57) ABSTRACT

An attachment system includes a first wall including an upper side and a lower side, and a second wall extending from the lower side of the first wall and including a front side and a rear side formed on an opposite side from the front side and including one or more retainers. The attachment system also includes a third wall including a first side and a second side formed on an opposite side of the first side, and a first end removably coupled to the second wall in a first configuration and a second end spaced from the first end and configured to be selectively engaged with the one or more retainers in a second configuration.

### CROSS REFERENCE TO RELATED APPLICATIONS

This application claims priority under 35 U.S.C. §119(e) to U.S. Provisional Application 63/762,122, filed on February 24, 2025. The disclosure of this prior application is considered part of the disclosure of this application and is hereby incorporated by reference in its entirety.

### FIELD

The present disclosure relates generally to an adjustable electronic shelf label holder for merchandise display systems.

### BACKGROUND

This section provides background information related to the present disclosure and is not necessarily prior art.

In self-service retail establishments, such as drug stores, grocery stores, and similar venues, products are typically displayed on racks with vertically spaced shelves. These shelves are organized in rows to facilitate customer access and product visibility. The dynamic nature of retail environments necessitates frequent stock changes, which can involve adding or removing products, updating prices, and modifying promotional information. Traditional labeling systems in these settings often require significant manual effort to update, leading to inefficiencies and potential errors. The process of changing labels can be time- consuming, particularly in large stores with extensive product ranges. This inefficiency can detract from the overall customer experience and increase operational costs. To address these challenges, there is a need for an improved system that allows for the easy addition or removal of labels on existing product rails. Specifically, these systems are designed for attaching electronic or digital shelf labels to shelves. Such a system would streamline the process of updating product information, reduce the likelihood of errors, and enhance the overall efficiency of retail operations. This invention aims to provide a solution that meets these needs, offering a more user-friendly and effective approach to product labeling in self-service retail environments.

### SUMMARY

One aspect of the disclosure provides an attachment system for securing a display device to a retail shelf. The system includes a first wall including an upper side and a lower side, and a second wall extending from the lower side of the first wall and including a front side and a rear side formed on an opposite side from the front side and including one or more retainers. The system also includes a third wall including a first side and a second side formed on an opposite side of the first side, and a first end removably coupled to the second wall in a first configuration and a second end spaced from the first end and configured to be selectively engaged with the one or more retainers in a second configuration.

Implementations of the disclosure may include one or more of the following optional features. In some examples, the system may further include a receptacle positioned between a first retaining flange extending the front side of the second wall, and a second retaining flange extending from the front side of the second wall and opposing the first retaining flange. In some examples, the first wall includes one or more cleats coupled to and extending from the lower side. In these examples, the first wall includes one or more cleats coupled to and extending from the lower side. In these examples, the cleats of the third wall may face the cleats of the first wall when the third wall is in the second configuration. In some examples, the second end of the third wall includes a coupler configured to mate with the one or more retainers. In these examples, the coupler may include a first prong extending in a first direction from the second end and a second prong extending in a second direction from the second end.

In some examples, each of the one or more retainers include pairs of resilient fingers that cooperate to define sockets. In these examples, the sockets may be configured to receive a portion of the third wall and position the third wall substantially parallel to the second wall. Alternatively, each socket can include a necked portion and a bulb portion. Another aspect of the disclosure provides an attachment system for securing a display device to a retail shelf. The system includes an upper wall including a top side and a bottom side, and a front wall extending transversely from the bottom side of the upper wall in a first direction and including a first side defining a display receptacle and an opposite second side including one or more retainers. The system also includes a clip including a clip wall and extending from a first end to a second end and including a coupler disposed at one of the first end or the second end

Another aspect of the disclosure provides an attachment system for securing a display device to a retail shelf. The system includes an upper wall including a top side and a bottom side, and a front wall extending transversely from the bottom side of the upper wall in a first direction and including a first side defining a display receptacle and an opposite second side including one or more retainers. The system also includes a clip including a clip wall and extending from a first end to a second end and including a coupler disposed at one of the first end or the second end configured to selectively engage the one or more retainers of the front wall.

Implementations of the disclosure may include one or more of the following optional features. In some examples, the upper wall includes a plurality of cleats disposed along the bottom side. In these examples, the clip may include a plurality of cleats arranged along the clip wall. In some implementations, the cleats of the clip face the cleats of the upper wall when the coupler is engaged with the one or more retainers.

In some examples, the first end of the clip is removably attached to at least one of the upper wall or the front wall. In these examples, the first end of the clip can be attached to the bottom side of the upper wall.

In some examples, the coupler includes a first prong extending in a first direction from the second end and a second prong extending in a second direction from the second end. In these examples, each of the retainers defines a socket and each of the prongs is configured to be selectively engaged with one of the sockets. In some implementations, each of the one or more retainers each include a first retainer finger and a second retainer finger cooperating to define the socket. In these implementations, each socket includes a necked portion and a bulb portion. This section provides a general summary of the disclosure, and is not a comprehensive disclosure of its full scope or all of its features.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected configurations and not all possible implementations, and are not intended to limit the scope of the present disclosure.

FIG. 1 is a top front perspective view of an example of an electronic shelf label (ESL) holder according to principles of the present disclosure; FIG. 2 is a rear view of the ESL holder of FIG. 1; FIG. 3 is a front view of the ESL holder of FIG. 1; FIG. 4 is a right side view of the ESL holder of FIG. 1; FIG. 5 is a left side view of the ESL holder of FIG. 1;

FIG. 6 is a top view of the ESL holder of FIG. 1; FIG. 7 is a bottom view of the ESL holder of FIG. 1; FIG. 8 is a left side view of the ESL holder of FIG. 1, showing a clip decoupled from an upper wall;

FIG. 9 is an enlarged left side view of the ESL holder of FIG. 8, showing the clip being engaged with a retainer of a front wall;

FIG. 10 is an enlarged left side view of the ESL holder of FIG. 8, showing the clip fully engaged with the retainer of the front wall;

FIG. 11 is a left side view of the ESL holder of FIG. 1, showing a configuration of a clip arranged in retainers of a front wall; and

FIG. 12 is a left side view of the ESL holder of FIG. 1, showing another configuration of the clip arranged in retainers of the front wall.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

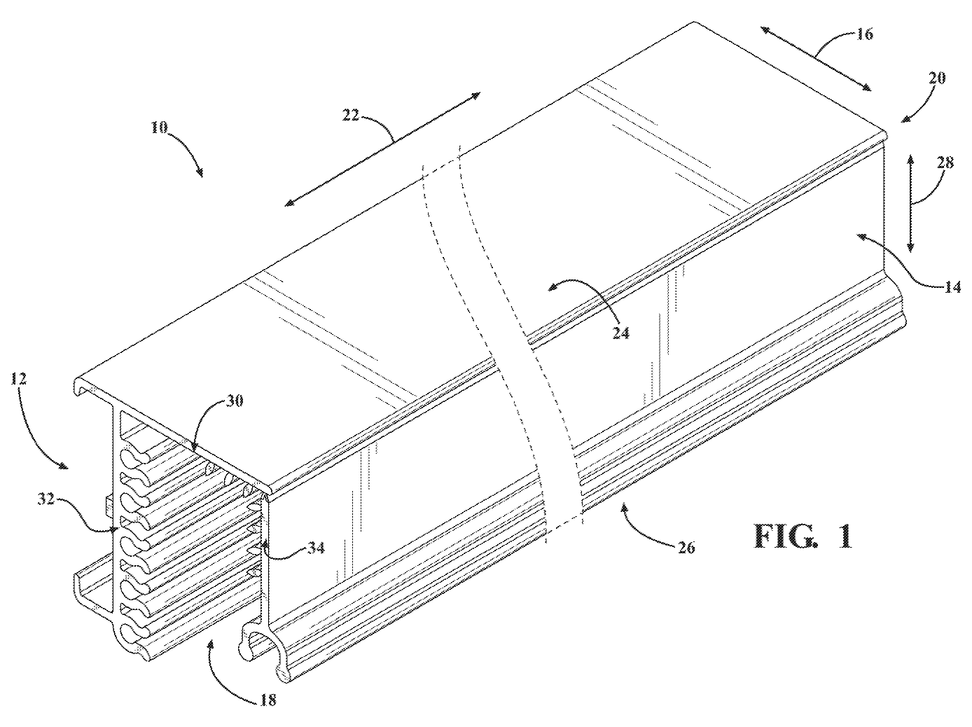

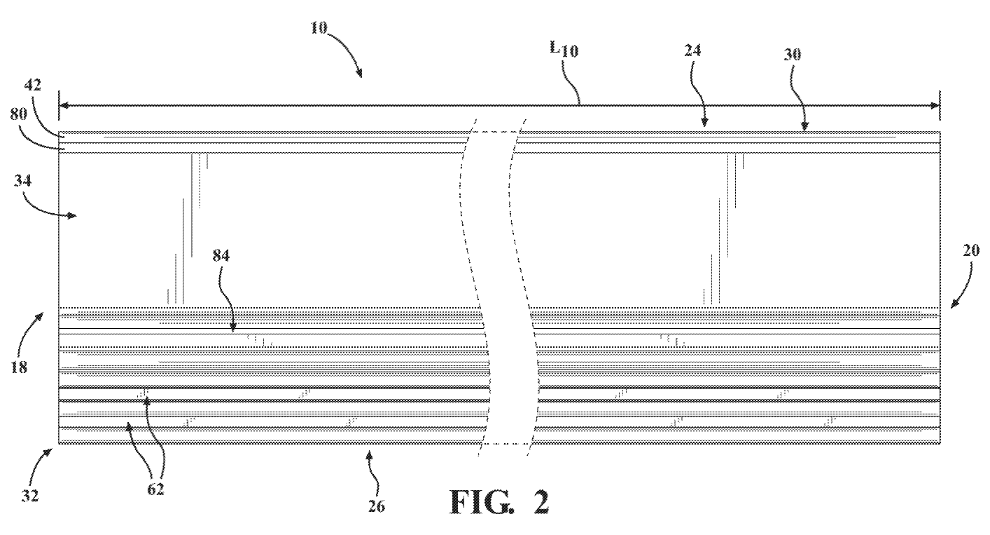

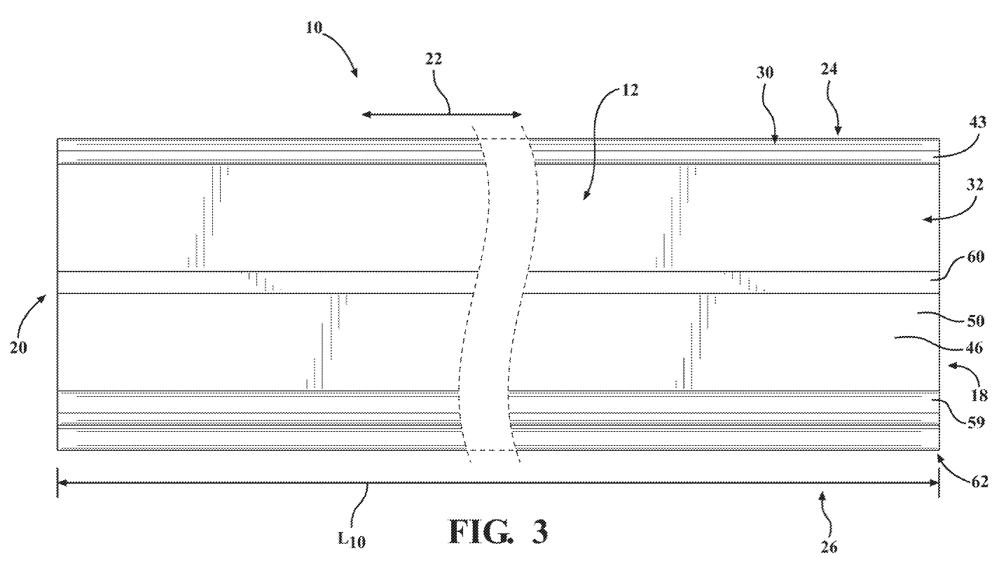

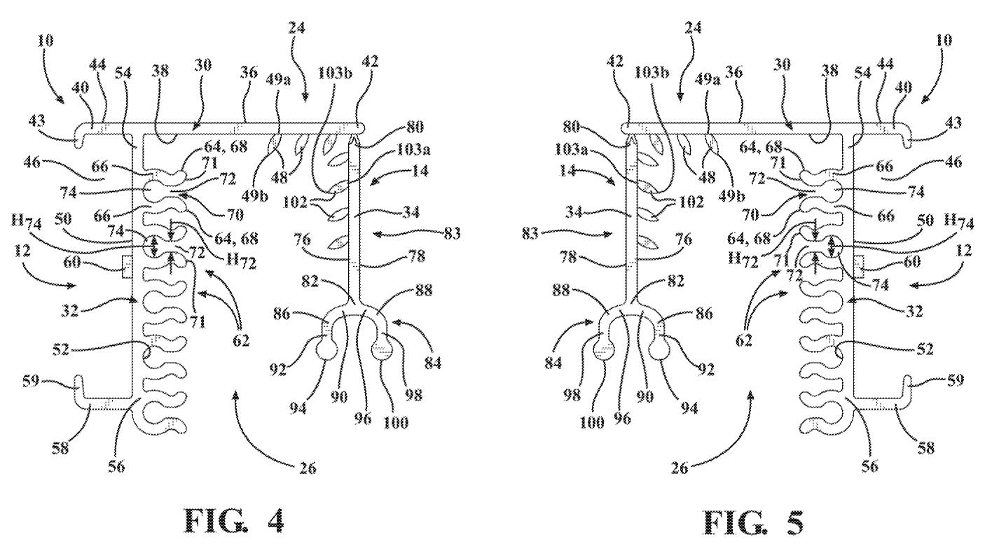

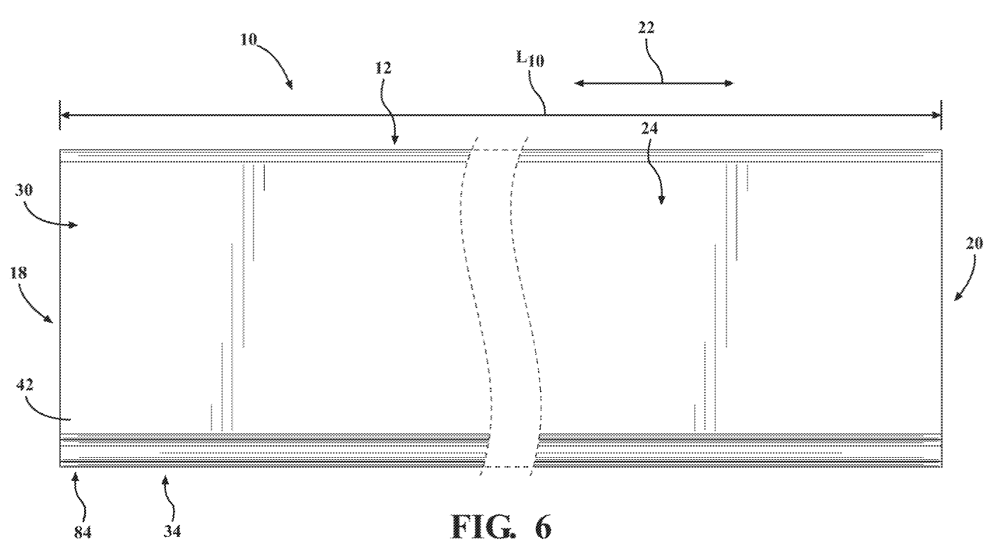

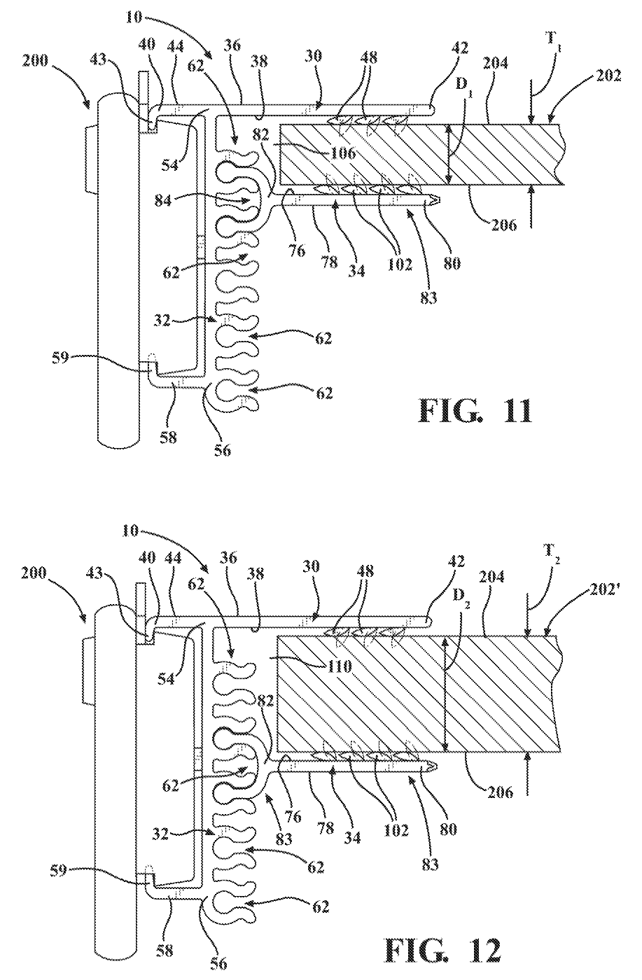

Referring to FIGS. 1-10, an attachment system 10 for securing a display device 200 (FIGS. 11 and 12) to a retail shelf 202 is generally shown. The attachment system 10 may be formed of a known suitable plastic, such as a thermoplastic extrusion, or metal, such as an aluminum extrusion and may be installed on a front surface (i.e., a front edge) of the shelf 202, or other suitable base surface for displaying the display device 200. The shelf 202 may be located in a store or other suitable location where consumers are able to purchase merchandise.

With reference to FIG. 1, the attachment system 10 includes a first or front side 12 and a second or rear side 14 spaced from the front side 12 with respect to a first axis 16. The attachment system 10 includes a first end 18 and a second end 20 spaced from the first end 18 with respect to a second axis 22. The attachment system 10 has a length Lio extending between the first end 18 and the second end 20. FIGS. 1-3 and 6-7 include broken lines which signifies that the attachment system 10 can be provided a different lengths Lio. The attachment system 10 also includes an upper end 24 and a lower end 26 spaced from the upper end 24 with respect to a third axis 28. In the present illustrative example, the first axis 16, the second axis 22, and the third axis 28 are arranged perpendicular to one another.

With continued reference to FIG. 1, the attachment system 10 includes a first or upper wall 30, a second or front wall 32 extending from the upper wall 30, and a detachable clip or third wall 34 extending from the upper wall 30. In some configurations, third wall 34 is provided in a kit and is referred to as a clip 34 that is separate from the upper wall 30 and/or the front wall 32. The present disclosure discusses the configuration where the third wall 34 is initially removably coupled to the upper wall 30 and/or the front wall 32. In doing so, the third wall 34 is referred to as having a first configuration (FIGS. 4 and 5) where the third wall 34 is initially removably coupled to the upper wall 30 and/or the front wall 32 and a second configuration (FIGS. 11 and 12) where the third wall 34 is selectively positioned and coupled to the front wall 32. Note, however, the principles of the present disclosure equally apply to the configuration where the third wall 34 is independently provided in a detached state as the clip 34.

With reference to FIGS. 4 and 5, the upper wall 30 includes a top side 36 and a bottom side 38 formed on an opposite side of the top side 36. The top side 36 and the bottom side 38 each extend between a front end 40 and a back end 42 spaced from the front end 40. Optionally, the upper wall 30 can include a first retaining flange 44 coupled to and extending from the front end 40. As shown, the first retaining flange 44 includes a lower lip 43 depending from a bottom side of the first retaining flange 44. As will be discussed in more detail below, the first retaining flange 44 defines a portion of a receptacle 46 that is configured for receiving and retaining a display device 200 (e.g., an electronic shelf label or display) (FIGS. 11 and 12). The first retaining flange 44 and/or a portion of the front end 40 are resilient, which is desirable for facilitating attachment of the display device 200 with respect to the attachment system 10. In the illustrated example, the first retaining flange 44 is integrally and continuously formed with the upper wall 30 of the attachment system 10. However, in other examples, the first retaining flange 44 may be independently formed from the upper wall 30. For example, the first retaining flange 44 may be spaced from the upper end 54 of the front wall 32.

The upper wall 30 also includes one or more cleats 48 that are coupled to and extend away from the bottom side 38 of the upper wall 30. The cleats 48 are configured to bend toward the bottom side 38 of the upper wall 30, as shown in FIGS. 11 and 12. According to one aspect, the cleats 48 provide tension and/or traction with respect to a shelf 202 and, more particularly, an upper surface 204 of the shelf 202. The cleats 48 are desirable for inhibiting removal of the attachment system 10 from the shelf 202. In the illustrated example, the cleats 48 include a plurality of the cleats 48 arranged in series along the direction of the first axis 16. Thus, a first one of the cleats 48 is disposed adjacent to the back end 42 of the upper wall 30 and subsequent ones of the cleats 48 are spaced along the direction of the first axis 16 towards the front end 40. In the illustrated example, each of the cleats 48 is embodied as an elongate rib that extends along the direction of the second axis 22 between the first end 18 of the attachment system 10 and the second end 20 of the attachment system 10. Each of the cleats 48 has an elliptical shape defining a major axis extending from a proximal end 49a attached to the bottom side 38 of the upper wall 30 and an opposite distal end 49b defining a sharp tip, which may function to grip a surface of the shelf 202 during use. As shown, the major axis of each cleat 48 may be naturally orientated at an oblique angle in a direction away from the back end 42 of the upper wall 30 when the cleat 48 is in an unbiased state.

With continued reference to FIGS. 4 and 5, the front wall 32 extends from the bottom side 38 of the upper wall 30 and includes a front side 50 and a rear side 52 formed on an opposite side from the front side 50. The front wall 32 has an upper end 54 adjacent to the upper wall 30 and a lower end 56 spaced from the upper end 54. The front wall 32 can include a second retaining flange 58 that is coupled to and extends away from the front side 50 of the front wall 32. A front lip 59 portion of the second retaining flange 58 extends toward the first retaining flange 44 and defines a portion of the receptacle 46. The second retaining flange 58 is resilient, which can be desirable for facilitating attachment of the display device 200 with respect to the attachment system 10. In at least one configuration, the front wall 32 includes a spacer or rail 60 coupled to the front side 50 and arranged between the first retaining flange 44 and the second retaining flange 58. The spacer 60 is configured to engage a portion of the display device 200 so that a portion of the display device 200 contacts the first retaining flange 44 and the second retaining flange 58 (FIGS. 11 and 12). In other words, the spacer 60 is desirable for maintaining the orientation of the display device 200 within the receptacle 46. According to one aspect, the spacer 60 can be a spring or biasing member (e.g., a resilient or compressible material) that supplies a force on a portion of the display device 200 to bias the display device toward the first and second retaining flanges 44, 58.

The front wall 32 also includes one or more retainers or channels 62 coupled to and extending from the rear side 52, as shown in FIGS. 4 and 5. The retainers 62 are configured to receive a portion of the clip 34 and to maintain the orientation of the clip 34 with respect to the upper wall 30, as shown in FIGS. 11 and 12. For instance, the retainers 62 each include one or more fingers 64 that each have a proximal end 66 coupled to the rear side 52 and a distal end 68 spaced from the proximal end 66. The fingers 64 are positioned with respect to each other in pairs and define sockets 70 that face away from the rear side 52 of the front wall 32. The sockets 70 each include a necked portion 72 adjacent to the opening 71 of the socket 70 and a bulb portion 74 disposed inwardly from the necked portion 72 relative to the opening 71. As shown, the necked portion 72 of each socket 70 defines portion of the socket 70 having a narrowed height H7n relative to the opening while the bulb portion 74 defines a portion of the socket 70 having a greater height H₇₄ than the necked portion 72. Optionally, the distal ends 68 of each of the fingers 64 may be flared outwardly relative to the necked portion 72 and the distal end 68 of an opposing one of the fingers 64 for a respective socket 70 to define a tapered opening leading to the necked portion 72. The fingers 64 are resilient and are configured to bend (i.e., flex) away from each other to receive a portion of the clip 34 within the socket 70. As such, the fingers 64 are configured to capture and retain one or more portions of the clip 34 within respective ones of the sockets 70 so that the clip 34 is cantilevered with respect to the front wall 32, as shown in FIGS. 11 and 12. According to another aspect, the retainers 62 are configured to receive a portion of the clip 34 substantially parallel to the upper wall 30.

Turning again to FIGS. 3 and 4, the clip 34 (i.e., third wall) extends from the bottom side 38 of the upper wall 30 and includes a first side 76 and a second side 78 formed on an opposite side from the first side 76. The clip 34 has a first end 80 and a second end 82 spaced from the first end 80. In the first configuration (FIGS. 3 and 4), the first end 80 is removably coupled to the bottom side 38 of the upper wall 30. While the illustrated example shows the first end 80 coupled to the bottom side 38 adjacent to the second end 42, the first end 80 may be coupled to the bottom side away from the second end 42. In other words, with reference to FIG. 8, a user can grip the clip 34 and bend, snap, or otherwise decouple the clip 34 from the upper wall 30.

The clip 34 includes a clip wall 83 that extends from the first end 80 toward the second end 82 and is attached to a coupler 84. The coupler 84 can be disposed at one of the first end 80 or the second end 82 and is configured to selectively engage the one or more retainers 62 of the front wall 32. In the present illustrative example, the coupler 84 is disposed at the second end 82 and includes a first prong 86 extending in a first direction from the second end 82 and a second prong 88 extending in a second direction from the second end 82. The first prong 86 includes a proximal end 90 coupled to and extending from the first side 76 and a distal end 92 spaced from the proximal end 90. A portion of the first prong 86 between the proximal end 90 and the distal end 92 is configured to cooperate (i.e., interface) with the necked portion 72 of one of the retainers 62. The first prong 86 can also include a knob 94 that cooperates (i.e., interfaces) with the bulb portion 74 of the same retainer 62. The second prong 88 includes a proximal end 96 coupled to and extending from the second side 78 and a distal end 98 spaced from the proximal end 96. A portion of the second prong 88 between the proximal end 96 and the distal end 98 is configured to cooperate with the necked portion 72 of one of the retainers 62 arranged adjacent to the retainer 62 occupied by the first prong 86. The second prong 88 can also include a knob 100 that cooperates with the bulb portion 74 of the same retainer 62. Optionally, with reference to FIGS. 11 and 12, when the coupler 84 is arranged in the retainers 62, the first end 80 of the clip 34 is aligned with the second end 42 of the upper wall 30 along the direction of the first axis 16.

The clip 34 also includes one or more cleats 102 that are coupled to and extend away from the first side 76 of the clip 34. The cleats 102 are configured to bend toward the first side 76 of the clip 34, as shown in FIGS. 11 and 12. According to one aspect, the cleats 102 provide tension and/or traction with respect to a lower surface 206 of the shelf 202 and are desirable for inhibiting removal of the attachment system 10 from the shelf 202. In the illustrated example, the cleats 102 include a plurality of the cleats 102 arranged in series along the direction of the third axis 28. Thus, a first one of the cleats 102 is disposed adjacent to the first end 80 of the clip wall 83 and subsequent ones of the cleats 102 are spaced along the direction of the third axis 28 towards the second end 82. In the illustrated example, each of the cleats 102 is embodied as an elongate rib that extends along the direction of the second axis 22 between the first end 18 of the attachment system 10 and the second end 20 of the attachment system 10. Each of the cleats 102 has an elliptical shape defining a major axis extending from a proximal end 103a attached to the first side 76 of the clip 34 and an opposite distal end 103b defining a sharp tip, which may function to grip a surface of the shelf 202 during use. As shown, the major axis of each cleat 102 may be naturally orientated at an oblique angle in a direction away from the first end 80 when the cleat 102 is in an unbiased state.

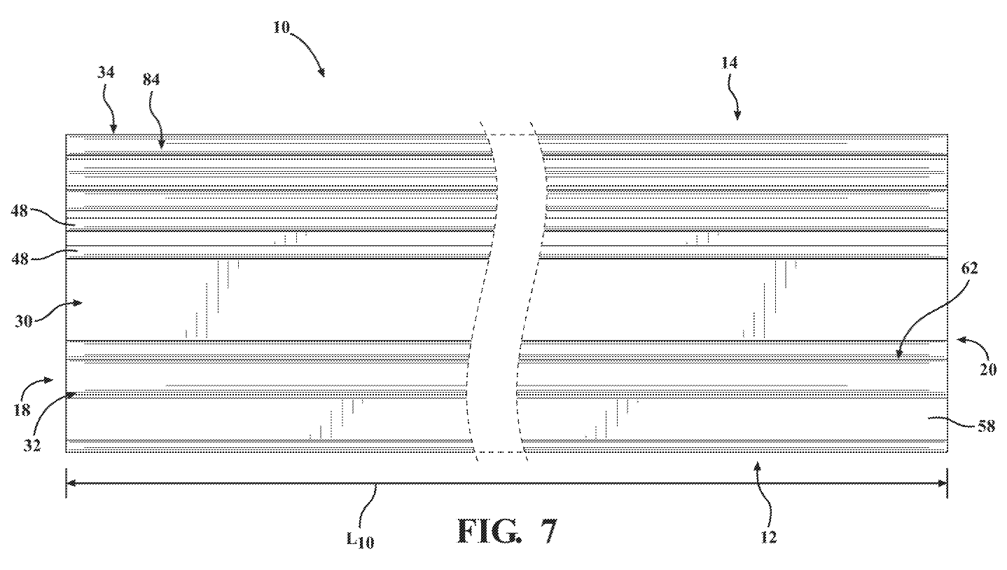

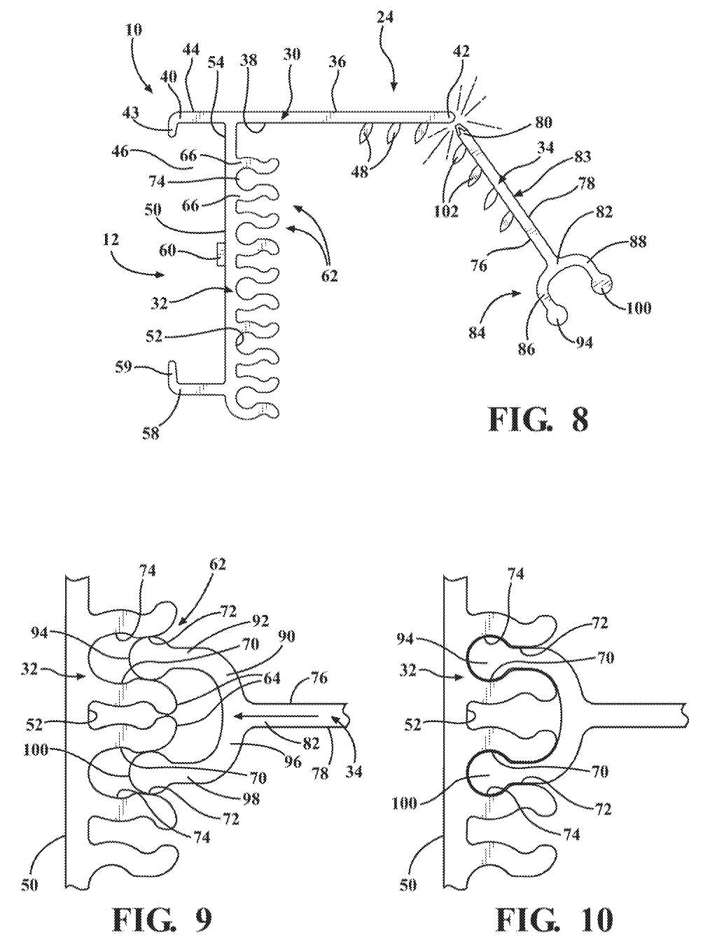

In assembly, a user or tool can bend, agitate, or otherwise move the clip 34 so that the first end 80 separates from the upper wall 30. The clip 34 can then be oriented with the clip wall 83 substantially parallel to the upper wall 30 so that the coupler 84 faces the retainers 62. Subsequently, with reference to FIG. 9, the knobs 94, 100 of the first prong 86 and the second prong 88 engage distal ends 68 of the fingers 64 of neighboring retainers 62, thereby causing the fingers 64 to diverge away from each other so that the first and second prongs 86, 88 can continue to advance into the sockets 70. With reference to FIG. 10, as the coupler 84 continues to advance into the sockets 70, the fingers 64 gradually return to their original positions and the knobs 94, 100 interface with bulb portions 74 of the sockets 70. Once the coupler 84 is selectively arranged in neighboring retainers 62, the clip 34 is maintained at a first distance D1 from the upper wall 30 and defines a first shelf opening 106, as shown in FIG. 11. The first shelf opening 106 is configured to receive the shelf 202 which has a first thickness T1. In another configuration, with reference to FIG. 12, the clip 34 and, more particularly, the coupler 84, can be selectively arranged in neighboring retainers 62 that are closer to the lower end 56 of the front wall 32 (i.e., farther away from the upper wall 30). The clip 34 is maintained at a second distance D2 from the upper wall 30 and defines a second shelf opening 110. The second shelf opening 110 is configured to receive a shelf 202' which has a second thickness T2 that is greater than the first thickness T1. Regardless of where the clip 34 is arranged in the retainers 62 between the upper end 54 and the lower end 56 of the front wall 32, the cleats 48 of the upper wall 30 oppose the cleats 102 of the clip 34. As the attachment system 10 is arranged and/or positioned on the shelf 202, 202', the upper surface 204 contacts the cleats 48 causing them to flex toward the bottom side 38 of the upper wall 30 and the lower surface 206 contacts the cleats 102 causing them to flex toward the first side 76 of the clip 34. As mentioned above, the cleats 48, 102 apply pressure on the shelf 202, 202' which inhibits removal of the attachment system 10 from the shelf 202, 202'. Additionally, the distal ends 49b, 103b of the cleats 48, 102 may engage the surfaces of the shelf 202, 202' to prevent detachment of the attachment system 10 from the shelf 202, 202'.

The display device 200 can be arranged in the receptacle 46 before or after the clip 34 is arranged in the retainers 62 of the front wall 32. Stated differently, the display device 200 can be arranged on the attachment system 10 before or after the attachment system 10 is arranged on the shelf 202.

The attachment system 10 provided in the foregoing description provides the benefit of allowing a single attachment system 10 to accommodate various sizes of retail shelves without the need for tools or significant modification. This configuration provides multiple advantages, such as simplifying attachment system inventory for store owners by providing a single attachment system 10 that accommodates a range of shelving configurations. Additionally, the attachment system 10 simplifies assembly by providing a tool-less apparatus that can be easily assembled and modified by employees.

The terminology used herein is for the purpose of describing particular exemplary configurations only and is not intended to be limiting. As used herein, the singular articles "a," "an," and "the" may be intended to include the plural forms as well, unless the context clearly indicates otherwise. The terms "comprises," "comprising," "including," and "having," are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being "on," "engaged to," "connected to," "attached to," or "coupled to" another element or layer, it may be directly on, engaged, connected, attached, or coupled to the other element or layer, or intervening elements or layers may be present. In contrast, when an element is referred to as being "directly on," "directly engaged to," "directly connected to," "directly attached to," or "directly coupled to" another element or layer, there may be no intervening elements or layers present. Other words used to describe the relationship between elements should be interpreted in a like fashion (e.g., "between" versus "directly between," "adjacent" versus "directly adjacent," etc.). As used herein, the term "and/or" includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as "first," "second," and other numerical terms do not imply a sequence or order unless clearly indicated by the context. Thus, a first element, component, region, layer or section discussed herein could be termed a second element, component, region, layer or section without departing from the teachings of the example configurations.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An attachment system for securing a display device to a retail shelf, the attachment system comprising:a first wall including an upper side and a lower side;a second wall extending from the lower side of the first wall and including a front side and a rear side formed on an opposite side from the front side and including one or more retainers; anda third wall including a first side and a second side formed on an opposite side of the first side, and a first end removably coupled to the second wall in a first configuration and a second end spaced from the first end and configured to be selectively engaged with the one or more retainers in a second configuration.

2. The attachment system of claim 1, further including a receptacle positioned between a first retaining flange extending from the front side of the second wall, and a second retaining flange extending from the front side of the second wall and opposing the first retaining flange.

3. The attachment system of claim 1, wherein the first wall includes one or more cleats coupled to and extending from the lower side.

4. The attachment system of claim 3, wherein the third wall includes one or more cleats coupled to and extending from at least one of the first side or the second side.

5. The attachment system of claim 4, wherein the cleats of the third wall face the cleats of the first wall when the third wall is in the second configuration.

6. The attachment system of claim 1, wherein the second end of the third wall includes a coupler configured to mate with the one or more retainers.

7. The attachment system of claim 6, wherein the coupler includes a first prong extending in a first direction from the second end and a second prong extending in a second direction from the
second end.

8. The attachment system of claim 1, wherein each of the one or more retainers includes pairs of resilient fingers that cooperate to define sockets.

9. The attachment system of claim 8, wherein the sockets are configured to receive a portion of the third wall and position the third wall substantially parallel to the second wall.

10. The attachment system of claim 8, wherein each socket includes a necked portion and a bulb portion.

11. An attachment system for securing a display device to a retail shelf, the attachment system comprising:an upper wall including a top side and a bottom side;a front wall extending transversely from the bottom side of the upper wall in a first direction and including a first side defining a display receptacle and an opposite second side including one or more retainers; anda clip including a clip wall and extending from a first end to a second end and including a coupler disposed at one of the first end or the second end configured to selectively engage the one or more retainers of the front wall.

12. The attachment system of claim 11, wherein the upper wall includes a plurality of cleats disposed along the bottom side.

13. The attachment system of claim 12, wherein the clip includes a plurality of cleats arranged along the clip wall.

14. The attachment system of claim 13, wherein the cleats of the clip face the cleats of the upper wall when the coupler is engaged with the one or more retainers.

15. The attachment system of claim 11, wherein the first end of the clip is removably attached to at least one of the upper wall or the front wall.

16. The attachment system of claim 15, wherein the first end of the clip is attached to the bottom side of the upper wall.

17. The attachment system of claim 11, wherein the coupler includes a first prong extending in a first direction from the second end and a second prong extending in a second direction from the second end.

18. The attachment system of claim 17, wherein each of the retainers defines a socket and each of the prongs is configured to be selectively engaged with one of the sockets.

19. The attachment system of claim 18, wherein each of the one or more retainers includes a first retainer finger and a second retainer finger cooperating to define the socket.

20. The attachment system of claim 19, wherein each socket includes a necked portion and a bulb portion.
